(19) United States
(12) Patent Application Publication
(10) Pub. No.: US 2008/0240300 A1
(43) Pub. Date: Oct. 2, 2008

(54) METHOD OF PROCESSING ABNORMAL MODULATION SIGNAL, AND RECEIVER HAVING ABNORMAL MODULATION SIGNAL COMPENSATION FUNCTION

(75) Inventors: Young-suk SONG, Suwon-si (KR); Myeong-gu LEE, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/830,261

(22) Filed: Jul. 30, 2007

(30) Foreign Application Priority Data
Mar. 29, 2007 (KR) 10-2007-0031138

(51) Int. Cl. H04L 27/14

(52) U.S. Cl. 375/334

(57) ABSTRACT

A method of detecting an abnormal modulation signal, and a receiver for compensating for an abnormal modulation signal are provided. The method includes demodulating an analog input signal, which has been modulated according to modulation parameters, using demodulation parameters corresponding to the modulation parameters to generate a baseband signal; sampling the baseband signal at a sampling rate; counting a number of samples having an amplitude greater than a threshold level during a detection window; and determining whether the analog input signal has been abnormally modulated, based on the number of samples counted. The receiver includes a baseband signal generator; a sampler; an abnormal modulation detector which counts a number of samples and determines whether the analog input signal has been abnormally modulated; a demodulation parameter modifier which modifies the demodulation parameters according to the determination result.

### CROSS-REFERENCE TO RELATED PATENT APPLICATION

This application claims priority from Korean Patent Application No. 10-2007-0031138, filed on Mar. 29, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to a receiver for receiving a modulation signal, and more particularly, to detecting and processing an abnormal modulation signal modulated by non-standard modulation parameters and a receiver having an abnormal modulation signal compensation function.

2. Description of the Related Art

According to the development of electronic engineering, various modulation and demodulation methods for transmitting a signal a long distance have been developed. Modulation is a technology for reducing distortion of a communication signal and extending a transmittable area by converting the communication signal to a high-frequency band using a predetermined carrier wave, and demodulation is a technology for extracting an original signal from a modulated signal. Examples of related art analog modulation and demodulation methods are Amplitude Modulation (AM), Frequency Modulation (FM), and Phase Modulation (PM) methods. Parameters used to modulate and demodulate a signal are standardized according to each nation in which the modulation and demodulation methods are used, and in nations observing a same communication standard, a same receiver can receive broadcasted signals.

However, in a broadcasting or transmission process of an analog television (TV) audio signal, an abnormal modulation signal may sometimes be transmitted differently from a standard modulation signal. This phenomenon occurs due to different communication environments of each nation, the performance of communication devices, communication conditions, interference between adjacent frequencies generated in a process of broadcasting a modulation signal, and so on. However, in order to increase a value of receivers, such as TVs, it is advantageous that an operation range of the receivers be widened so that even an abnormal modulation signal can be received and processed to normally operate. That is, even if an abnormal signal is received, it would be advantageous for receivers, such as TVs, to reproduce the abnormal signal to a signal closest to a normal signal for securing quality.

One of various abnormal modulation signals is a high-deviation signal generated by a broadcasting station or a relay station modulating a signal using higher modulation parameters than in normal FM modulation. That is, high-deviation denotes an effect occurring when a specific local broadcasting station (e.g., a terrestrial or cable broadcasting station) overmodulates an audio signal compared to a standardized input level. If a high-deviation signal is received, a receiver can generate a normal signal only if demodulation parameters are modified to fit the broadcast high-deviation signal.

Thus, related art receivers individually examine a signal to determine whether a signal broadcasted in a specific area is a high-deviation signal, create a database based on the examination result, and maintain the database. Thereafter, a user searches for an operating area of a related art receiver from the database, and if a high-deviation signal is broadcasted in the operating area, the user manually sets demodulation parameters of the receiver, such as a TV, to correspond to the high-deviation signal. Thus, if the demodulation parameters are set to correspond to the high-deviation signal, when a microcomputer of the receiver receives the high-deviation signal, the microcomputer modifies the demodulation parameters in response to the high-deviation signal. The modified demodulation parameters include an FM prescaler value, an FM filter bandwidth, and so on, and these demodulation parameters are differently modified according to a grade of abnormal modulation of the high-deviation signal (e.g., 200% abnormal modulation or 400% abnormal modulation). An amplitude of an output signal is adjusted to fit a set abnormal modulation mode, resulting in preventing a clipping effect in a Digital to Analog Converter (DAC) and an audio amplifier. As described above, a demodulation mode is manually set for related art receivers.

FIG. 1 illustrates a channel environment in which a related art TV receiver operates.

As illustrated in FIG. 1, the TV receiver receives modulation signals broadcasted by means of three channels (channels A, B, and C). It is assumed that channel A transmits a high-deviation modulation signal in mono mode, channel B transmits a normal modulation signal in mono mode, and channel C transmits a normal modulation signal in stereo and dual modes. In this case, since the TV receiver is always set in a high-deviation mode, the following problems occur.

FIG. 2 illustrates outputs generated when a related art TV receiver receives modulation signals modulated using various modulation parameters.

When a normal modulation signal is received by means of channel B, if an analog audio decoder of the receiver operates in a normal demodulation mode, a normal output can be obtained. This case is illustrated in FIG. 2A. When an abnormal modulation signal is received, if the analog audio decoder of the receiver operates in the normal demodulation mode, an output having a 200% output level is obtained. This case is illustrated in FIG. 2B. Thus, in order to normally process the high-deviation signal with 200% abnormal modulation, the analog audio decoder must operate in a 200% demodulation mode corresponding to the 200% abnormal modulation. Then, a normal output can be obtained, and this is as illustrated in FIG. 2C.

However, for the related art receivers, since the demodulation mode is manually set, if signals modulated in different modes are received as illustrated in FIG. 1, the related art receiver may abnormally operate. For example, when the analog audio decoder operates in the 200% demodulation mode, if a normal modulation signal is received by means of channel A, an output level of an output signal is reduced by half. In addition, when an FM scaler of the analog audio decoder is set to a 400% high-deviation mode, if a normal modulation signal is received by means of channel A, an audio value is reduced to ¼. Thus, in terms of customers, an audio output level is reduced compared to a level in a normally broadcasted channel. In addition, since an audio level is changed every time a channel is changed, an audio setting must be adjusted every time a channel is changed.

Furthermore, if a receiver operates in a Broadcast Television System Committee (BTSC) or Electronic Industries Association of Japan (EIAJ) mode, when FM mono demodulation is performed, not only a mono signal but also an AM or FM re-modulated stereo or Second Audio Program (SAP) signal component are demodulated. In the high-deviation mode, if an FM prescaler value of a first FM demodulated signal is used as ½ or ¼ of a normal level, an energy level of a stereo/SAP (dual) signal is also decreased by that amount. Due to this effect, the demodulation performance of the stereo/SAP (dual) signal is degraded, and a stereo/SAP (dual) pilot signal may not be detected. In particular, if a modulated signal is transmitted with weak power, a pilot signal may not be detected, resulting in loss of an audio signal itself.

Thus, it would be advantageous to have a technology for reliably reproducing a demodulated signal by automatically detecting abnormal modulation of a modulated signal and demodulating a received signal using demodulation parameters corresponding to different modulation modes.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method of reliably processing an abnormally modulated broadcast signal by automatically detecting a high-deviation mode in which a broadcast signal is abnormally modulated and automatically modifying demodulation parameters to correspond to a detected modulation mode.

The present invention also provides a receiver for acquiring a stable output regardless of modulation modes of a geographical area in which the receiver is sold and used or modulation modes of channels, whereby the receiver, such as a TV, for receiving a broadcast signal can automatically detect whether a received modulation signal is abnormally modulated and demodulate the received modulation signal in response to a detected abnormal modulation mode.

According to an aspect of the present invention, there is provided a method of processing an abnormal modulation signal, the method comprising generating a baseband signal by demodulating an analog input signal, which has been modulated according to modulation parameters, using demodulation parameters corresponding to the modulation parameters; sampling the baseband signal at a sampling rate; counting a number of samples having an amplitude greater than a threshold level during a detection window; and determining whether the analog input signal has been abnormally modulated, based on the number of samples counted.

The determining whether the analog input signal has been abnormally modulated may be based on whether the number of samples counted is greater than a first number.

The method may further comprise if it is determined that the analog input signal has been abnormally modulated, modifying the demodulation parameters according to the determination result.

The generating of the baseband signal may comprise receiving the analog input signal; and generating the baseband signal by removing a carrier wave from the analog input signal and applying the demodulation parameters.

The determining of whether the analog input signal has been abnormally modulated may comprise counting a number of detection windows in which it is determined that abnormal modulation has occurred, for a time which is longer than a duration of each detection window; determining whether the number of detection windows counted is greater than a second number; and if it is determined that the number of detection windows counted is greater than the second number, determining that the analog input signal has been abnormally modulated.

The determining of whether the analog input signal has been abnormally modulated may further comprise if it is determined that the analog input signal has been abnormally modulated, determining a grade of abnormal modulation by referring to the demodulation parameters used to demodulate the analog input signal, wherein the abnormal modulation signal is an overmodulation signal modulated using 200% or 400% modulation parameters compared to the modulation parameters.

According to another aspect of the present invention, there is provided a receiver having an abnormal modulation signal compensation function, the receiver comprising a baseband signal generator which generates a baseband signal by demodulating an analog input signal, which has been modulated according to modulation parameters, using demodulation parameters corresponding to the modulation parameters; a sampler which samples the baseband signal at a sampling rate; an abnormal modulation detector which counts a number of samples having an amplitude greater than a threshold level during a detection window and determines whether the analog input signal has been abnormally modulated, based on the number of samples counted; a demodulation parameter modifier which modifies the demodulation parameters according to the determination result if it is determined that the analog input signal has been abnormally modulated; and an output unit which synchronizes a result, which is obtained by demodulating the analog input signal according to the modified demodulation parameters, with an image signal and outputs the synchronization result.

The baseband signal generator may comprise a mixer which receives the analog input signal and mixes the analog input signal with a mixing frequency; a carrier wave remover which removes a carrier wave from the analog input signal; and a demodulator which generates the baseband signal by applying the demodulation parameters to an output of the carrier wave remover, wherein the output of the carrier wave remover is a mono signal, a stereo signal, or a dual signal.

The abnormal modulation detector may count a number of detection windows in which it is determined that abnormal modulation has occurred, for a time which is longer than a duration of each detection window, determine whether the number of detection windows counted is greater than a second number, and determine that the analog input signal has been abnormally modulated, if it is determined that the number of detection windows counted is greater than the second number.

The abnormal modulation detector may determine a grade of abnormal modulation by referring to the demodulation parameters used to demodulate the analog input signal, if it is determined that the analog input signal has been abnormally modulated, wherein the abnormal modulation signal is an overmodulation signal modulated using 200% or 400% modulation parameters compared to the modulation parameters.

The analog input signal may be an amplitude-modulated Sound Intermediate Frequency (SIF).

### BRIEF DESCRIPTION OF THE DRAWINGS

The above and other aspects of the present invention will become more apparent by describing in detail exemplary embodiments thereof with reference to the attached drawings in which:

FIG. 1 illustrates a channel environment in which a related art television (TV) receiver operates;

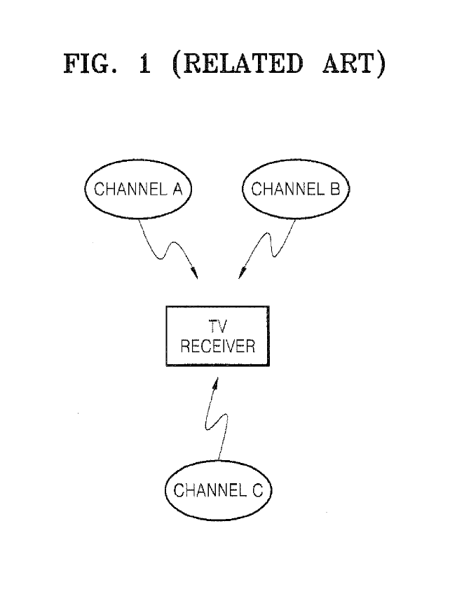

FIGS. 2A, 2B, and 2C illustrate outputs generated when a related art TV receiver receives modulation signals modulated using various modulation parameters;

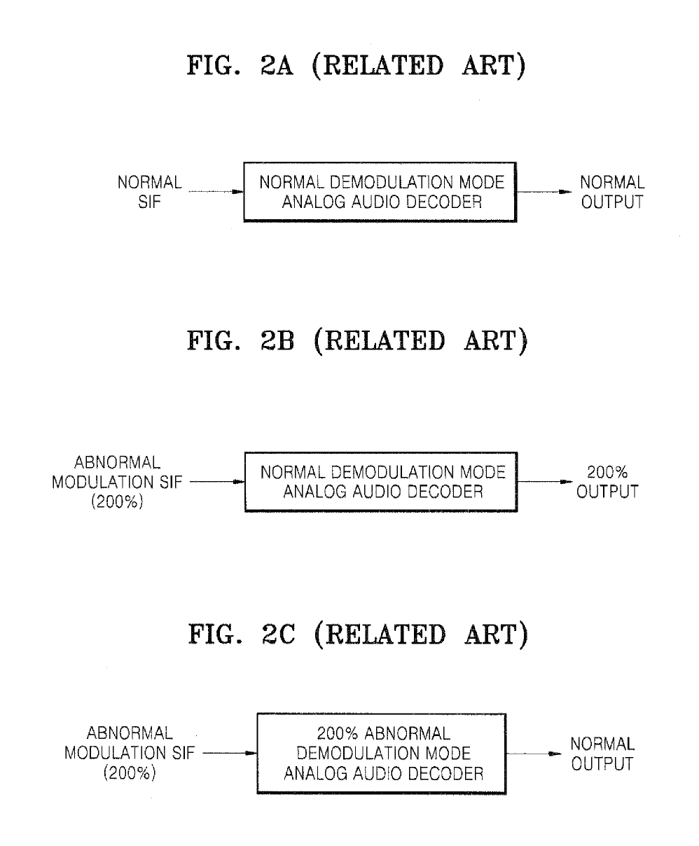

FIG. 3 is a flowchart of a method of processing an abnormal modulation signal according to an exemplary embodiment of the present invention;

FIGS. 4A and 4B illustrate amplitudes of detected samples for describing the method of processing an abnormal modulation signal, which is illustrated in FIG. 3;

FIG. 5 is a block diagram of a receiver according to an exemplary embodiment of the present invention; and

FIGS. 6A, 6B, and 6C illustrate outputs generated when a receiver according to an exemplary embodiment of the present invention receives abnormal modulation signals.

### DETAILED DESCRIPTION OF THE INVENTION

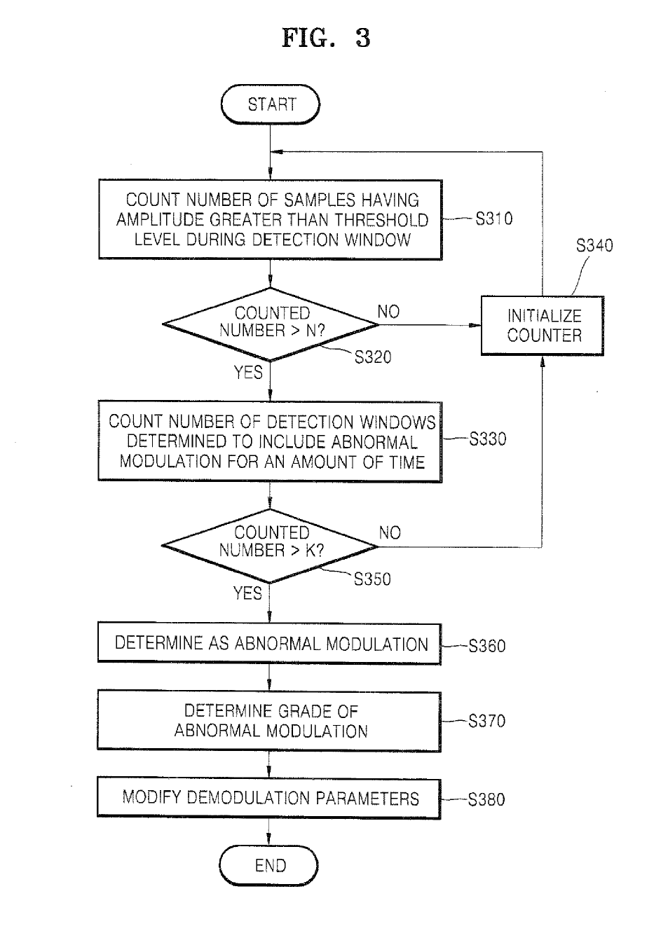

FIG. 3 is a flowchart of a method of processing an abnormal modulation signal according to an exemplary embodiment of the present invention.

Referring to FIG. 3, an analog input signal is received, and a baseband signal is generated by demodulating the analog input signal using demodulation parameters corresponding to a normal modulation mode. In this case, the analog input signal may be a signal modulated in the normal modulation mode or an abnormal modulation mode. The analog input signal may be an amplitude-modulated Sound Intermediate Frequency (SIF).

If the baseband signal is generated, the baseband signal is sampled at a sampling rate, and the number of samples having an amplitude greater than a threshold level during a detection window is counted in operation S310. The sampling rate may be predetermined. The detection window may be predetermined. The faster the sampling rate used in the sampling process is, the more accurate the sampling is, and the larger a processing load is. Thus, the sampling rate may be determined as an appropriate value, for example, 48 KHz. The detection window corresponds to a unit time for counting a number of samples and can be set to, for example, 1 ms.

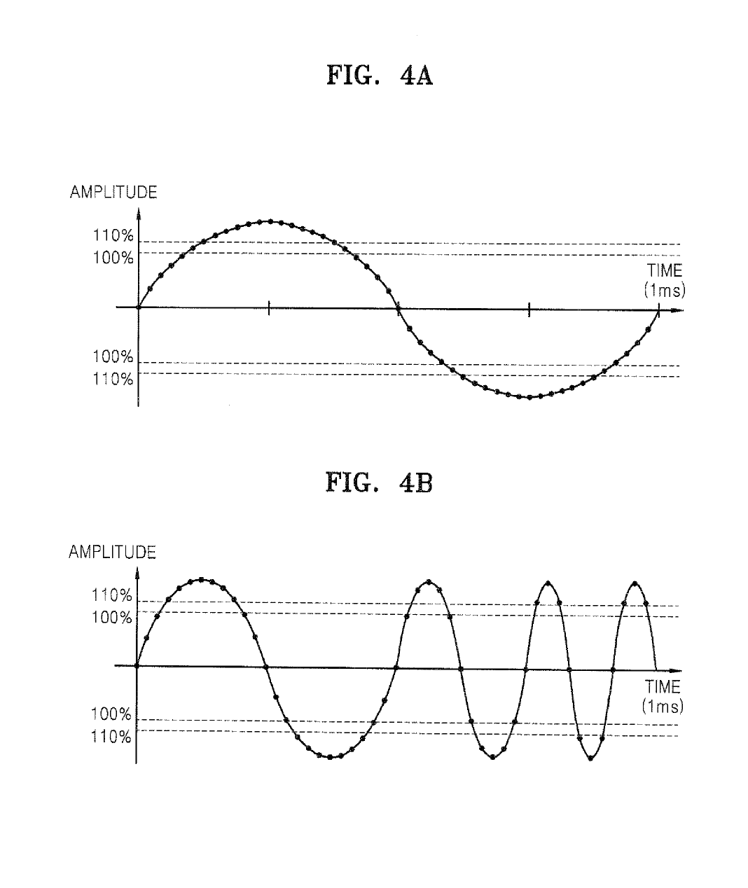

FIG. 4 illustrates amplitudes of detected samples for describing the method of processing an abnormal modulation signal, which is illustrated in FIG. 3.

As illustrated in FIG. 4, amplitudes of samples sampled at 48 KHz during the detection window of 1 ms are compared to a threshold level. The threshold level may be set to correspond to the maximum amplitude of a baseband signal in the normal modulation mode or, as shown in FIG. 4A, may be set to correspond to 110% of the maximum amplitude. For example, in FIG. 4A, if the threshold level corresponds to 110% of the maximum amplitude, the number of samples having an amplitude greater than the threshold level is about 15. In this case, if the absolute value of the amplitude of each sample is compared to the threshold level, the number of samples having an amplitude greater than the threshold level is about 30.

Returning to FIG. 3, the counted number is compared to a first number N in operation S320. For example, if the first number N is set to 20, since the number of samples of the high-deviation modulation signal illustrated in FIG. 4A is 30, it is determined that the analog input signal has been abnormally modulated. As described above, the first number N corresponds to a threshold number of samples in a unit window of a high-deviation modulation signal. In FIG. 4B, it is assumed that the threshold level is set to 110% of the maximum amplitude. In this case, the number of samples having an absolute value of an amplitude greater than 110% of the maximum amplitude is about 29. If the first number N is set to 35, it can be determined that the signal illustrated in FIG. 4B has not been abnormally modulated.

In order to more clearly determine whether the analog input signal has been abnormally modulated, a number of detection windows in which abnormal modulation is detected is counted for an amount of time in operation S330. The time may be predetermined. The amount of time may be a time longer than the detection window, for example 1000 ms. The number of detection windows counted in the amount of time is compared to a second number K in operation S350. For example, if the second number K is 100, when the number of detection windows is counted to be greater than 100 within 1000 ms, it can be determined in operation S360 that abnormal modulation has occurred. In this specification, abnormal modulation denotes a case where modulation has not been performed using normal modulation parameters, and may include overmodulation (or high-deviation modulation) and/or undermodulation. Although the number of samples having an amplitude greater than the threshold level during the detection window is counted in operation S310, undermodulation can also be detected by detecting a number of samples having an amplitude less than a threshold level. Thus, the present inventive concept is not limited to the detection of high-deviation modulation signal. However, hereinafter, for convenience of description, the high-deviation modulation case will be illustrated.

If the amount of time elapses, a counter is initialized in operation S340.

It is advantageous to use not only the number of samples having an amplitude greater than the threshold level during a detection window but also the number of detection windows in which abnormal modulation is detected in order to detect the abnormal modulation because a burst of noise may occur while a normally modulated signal is being broadcasted and transmitted. In such a case, amplitudes of almost all samples in several detection windows may be greater than the threshold level due to the burst of noise. Since a number of almost all samples in several detection windows is counted, the number of almost all samples in each of the several detection windows may exceed the first number N. Thus, even if a broadcast signal is normally modulated, if noise occurs while the broadcast signal is being broadcasted, it may be wrongly determined that the broadcast signal has been abnormally modulated.

However, if the number of detection windows in which abnormal modulation is detected is counted, it can be determined that only a few samples are greater than the threshold level in detection windows after the burst noise has disappeared. Thus, for example, since the number of detection windows, in which abnormal modulation is detected, for 1000 ms is less than the second number K, it is accurately detected that this signal is not an abnormally modulated signal.

If it is determined that the analog input signal is an abnormally modulated signal, a grade of abnormal modulation is determined in operation S370. The grade of abnormal modulation is to determine whether the analog input signal has been, for example, 200% or 400% overmodulated. In order to detect a 400% overmodulated signal, the threshold level may be adjusted to be higher. For example, by raising the threshold level two times and counting the number of samples again, a 400% overmodulated signal can be detected.

If the grade of abnormal modulation is determined, the demodulation parameters are modified to fit the determined grade of abnormal modulation in operation S380. A process of modifying the demodulation parameters in response to the grade of abnormal modulation will be described in detail later.

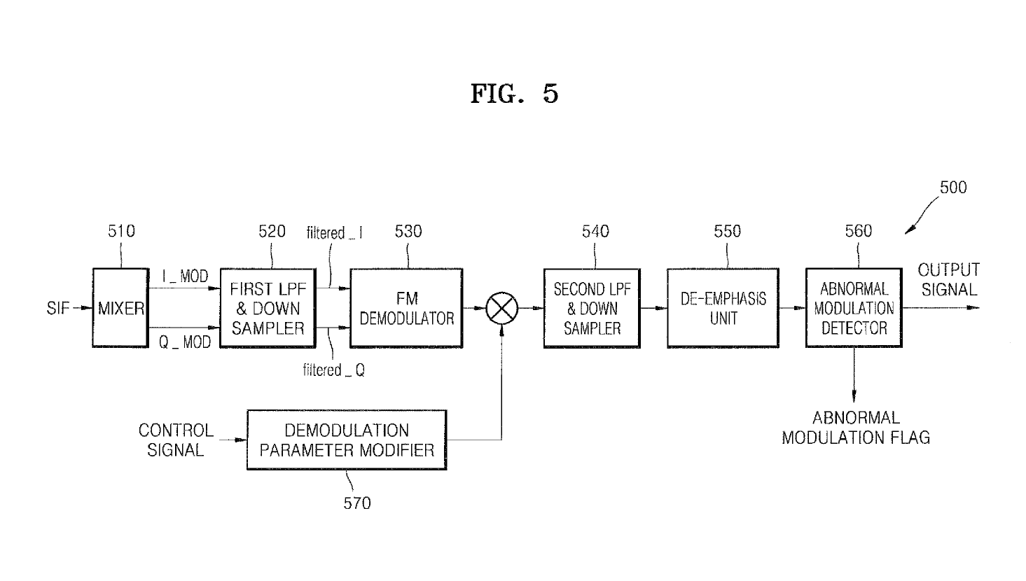

FIG. 5 is a block diagram of a receiver 500 according to an exemplary embodiment of the present invention.

Referring to FIG. 5, the receiver 500 includes a mixer 510, a first Low Pass Filter (LPF) & down sampler 520, an FM demodulator 530, a second LPF & down sampler 540, a de-emphasis unit 550, an abnormal modulation detector 560, and a demodulation parameter modifier 570.

The mixer 510 receives an SIF signal and generates two quadrature frequency modulated signals I_MOD and Q_MOD by mixing the received SIF signal with a carrier frequency. For example, the SIF signal is a signal transmitted by being carried on a 4.5 MHz carrier wave, which observes a Broadcast Television System Committee (BTSC) method. However, the present invention is not limited to the BTSC method, and the mixer 510 can receive a signal transmitted according to various standards, such as Near Instantaneously Companded Audio Multiplex (NICAM), or the like.

The generated quadrature modulated signals I_MOD and Q_MOD are transmitted to the first LPF & down sampler 520. The first LPF & down sampler 520 removes a carrier wave by low pass filtering the quadrature modulated signals I_MOD and Q_MOD and down-sampling them. The filtered quadrature modulation signals filtered_I and filtered_Q output from the first LPF & down sampler 520 are input to the FM demodulator 530. The FM demodulator 530 generates a baseband signal by FM demodulating the filtered quadrature modulation signals filtered_I and filtered_Q.

The demodulation parameter modifier 570 modifies FM demodulation parameters by operating according to a control signal received from a controller (not shown). As described below, the controller generates the control signal for controlling the demodulation parameter modifier 570 in response to an abnormal modulation flag received from the abnormal modulation detector 560. For example, the demodulation parameter modifier 570 may be an FM prescaler modifying the FM demodulation parameters.

The second LPF & down sampler 540 receives a stereo or Second Audio Program (SAP) signal and performs low pass filtering and down-sampling of the stereo/SAP signal. By doing this, the second LPF & down sampler 540 can output, for example, a mono sound signal. The output mono sound signal is processed by the de-emphasis unit 550 and output as a mono output signal.

The abnormal modulation detector 560 detects whether a signal output from the de-emphasis unit 550 is an abnormally modulated signal. An operation of the abnormal modulation detector 560 has been described with reference to FIGS. 3 and 4. That is, the abnormal modulation detector 560 samples the output sound signal and detects a number of samples and a number of detection windows in which the number of samples having an amplitude greater than a threshold level is greater than a number. If the number of detection windows corresponds to a time which is longer than an amount of time, it can be determined that the output sound signal corresponds to abnormal modulation. If the abnormal modulation detector 560 determines that the output sound signal corresponds to abnormal modulation, the abnormal modulation detector 560 generates an abnormal modulation flag and transmits it to the controller. In response to the abnormal modulation flag, the controller controls the demodulation parameter modifier 570 to modify demodulation parameters. In this case, as described above, the abnormal modulation detector 560 can also detect a grade of abnormal modulation, and the demodulation parameter modifier 570 can modify the demodulation parameters according to the grade of abnormal modulation. For example, the abnormal modulation detector 560 can detect whether the abnormally modulated signal is 200% overmodulated or 400% overmodulated.

As illustrated in FIG. 5, by adding the abnormal modulation detector 560 to the receiver 500, the demodulation parameter modifier 570 can automatically modify the demodulation parameters, and thus, the receiver 500 can detect whether a received signal has been abnormally modulated and modify the demodulation parameters according to the detection result.

Although the receiver 500 receives and demodulates a mono SIF signal in FIG. 5, this does not limit the scope of the present invention. All receivers for demodulating all signals regardless of modulation methods of the signals and detecting abnormal modulation from a demodulation result are included in the technical scope of the present invention. For example, the received signal may be a stereo signal or a sound multiplexing signal. If received signal is a stereo signal, the receiver 500 may include a 4.5 MHz band pass filter (BPF) (not shown) receiving a sound signal and filtering the sound signal so that the sound signal has a 4.5 MHz frequency band, a 4.72 MHz BPF (not shown) receiving the sound signal and filtering the sound signal so that the sound signal has a 4.72 MHz frequency band, an L+R signal detector (not shown) receiving the signal input from the 4.5 MHz BPF and detecting a sum signal obtained by adding a left channel signal and a right channel signal, which are major channel signals, and an L−R and SAP signal detector (not shown) receiving the signal input from the 4.5 MHz BPF and detecting a difference signal for stereo broadcasting, which is obtained by subtracting the right channel signal from the left channel signal, and a SAP signal for dual language broadcasting. As described above, the receiver 500 can be applied to all configurations of receivers for automatically detecting, regardless of types of signals, whether a demodulation result corresponds to an abnormally modulated signal and modifying demodulation parameters according to the detection result.

An operation of the receiver 500 will now be described in detail.

The receiver 500 operates in a normal demodulation mode until an abnormal modulation signal (e.g., a high-deviation modulation signal) is detected. If a high-deviation modulation signal is not detected, the receiver 500 maintains the normal demodulation mode. Of course, if a stereo/SAP (dual) pilot is detected, the receiver 500 may change to a stereo/SAP (dual) mode.

If the abnormal modulation detector 560 detects an abnormal modulation signal, the abnormal modulation detector 560 activates the abnormal modulation flag, and according to a grade of the abnormal modulation, the controller controls the demodulation parameter modifier 570 to modify demodulation parameters. In this case, the controller may store in a memory (not shown) that a channel of the received modulation signal operates in the abnormal modulation mode.

As described above, abnormal modulation detector 560 can further detect a grade of abnormal modulation. In this case, as described above, if the abnormal modulation is detected once, it can be determined as a 200% abnormal modulation mode, and if the abnormal modulation is again detected for a signal which has initially been determined as being in a 200% abnormal modulation mode, it can be determined as a 400% abnormal modulation mode.

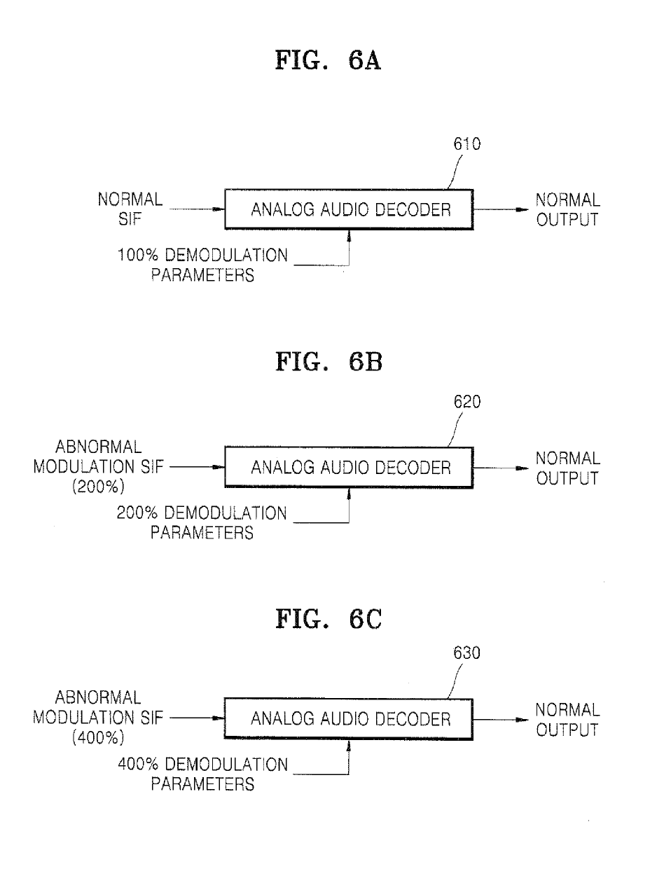

FIGS. 6A, 6B, and 6C illustrate outputs generated when a receiver according to an exemplary embodiment of the present invention receives abnormal modulation signals.

Each of analog audio decoders 610, 620, and 630 illustrated in FIGS. 6A-6C, respectively, can be understood to correspond to the receiver 500 illustrated in FIG. 5.

FIG. 6A illustrates a case where a normally modulated SIF signal is received. The analog audio decoder 610 detects that a channel through which the SIF signal is received operates in the normal modulation mode and demodulates the SIF signal in the normal demodulation mode. Thus, like in the related art, an amplitude of an output audio signal is not reduced differently from a case where the analog audio decoder 610 operates in the high-deviation mode.

FIG. 6B illustrates a case where a 200% abnormally modulated SIF signal is received. If abnormal modulation is detected while the analog audio decoder 620 is operating in the normal demodulation mode, the analog audio decoder 620 modifies demodulation parameters in response to a 200% demodulation mode. Thus, since the 200% abnormally modulated SIF signal is demodulated using 200% demodulation parameters, a normal output can be obtained. As described above, the analog audio decoder 620 can store in a memory that a channel through which the 200% abnormally modulated SIF signal is received operates in the 200% abnormal modulation mode.

FIG. 6C illustrates a case where a 400% abnormally modulated SIF signal is received. In this case, an output signal of the analog audio decoder 630 is detected as a 200% abnormally modulated SIF signal. Thus, the analog audio decoder 630 performs the abnormal modulation detection process once more. If the abnormal modulation is detected in this second abnormal modulation detection process, the analog audio decoder 630 can determine whether the received SIF signal has been 400% abnormally modulated. The analog audio decoder 630 modifies the demodulation parameters in response to a 400% demodulation mode. Thus, since the 400% abnormally modulated SIF signal is demodulated using 400% demodulation parameters, a normal output can be obtained from even the 400% abnormally modulated SIF signal. In this case, the analog audio decoder 630 can store in a memory that a channel through which the 400% abnormally modulated SIF signal is received operates in the 400% abnormal modulation mode.

Furthermore, the analog audio decoders according to exemplary embodiments of the present invention can accurately detect a pilot signal from a signal broadcasted according to a BTSC or EIAJ standard. That is, if a normally modulated signal is received, demodulation in which the 200% or 400% demodulation parameters are forcibly applied is not performed, and thus, an energy level of a demodulated stereo or SAP (dual) signal is normally maintained.

While the present inventive concept has been particularly shown and described with reference to exemplary embodiments thereof, it will be understood by those of ordinary skill in the art that various changes in form and details may be made therein without departing from the spirit and scope of the present invention. For example, the demodulation parameters described in the specification can include an FM scaler value, a filter bandwidth, and a threshold level for the samples.

As described above, according to exemplary embodiments of the present invention, an abnormally modulated broadcast signal can be reliably processed by automatically detecting a high-deviation mode in which a broadcast signal is abnormally modulated and automatically modifying demodulation parameters to correspond to a detected modulation mode.

In addition, since demodulation can be reliably performed by adaptively applying demodulation parameters corresponding to modulation parameters by which a broadcast signal is modulated, a pilot signal existing in a modulated signal can be accurately detected.

In addition, an abnormal modulation mode can be automatically detected, and a modulation signal can be demodulated in response to the detected abnormal modulation mode. Thus, since a stable output signal can be automatically obtained regardless of a modulation mode of an area in which receivers are sold and modulation modes of channels, competitiveness of receivers, such as TVs, can be significantly improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of processing an abnormal modulation signal, the method comprising:
demodulating an analog input signal, which has been modulated according to modulation parameters, using demodulation parameters corresponding to the modulation parameters to generate a baseband signal;
sampling the baseband signal at a sampling rate;
counting a number of samples having an amplitude greater than a threshold level during a detection window; and
determining whether the analog input signal has been abnormally modulated, based on the number of samples counted.

2. The method of claim 1, wherein the determining whether the analog input signal has been abnormally modulated is based on whether the number of samples counted is greater than a first number.

3. The method of claim 1, further comprising if it is determined that the analog input signal has been abnormally modulated, modifying the demodulation parameters according to the determination result.

4. The method of claim 1, wherein demodulating the analog input signal comprises:
receiving the analog input signal; and
removing a carrier wave from the analog input signal and applying the demodulation parameters to generate the baseband signal.

5. The method of claim 1, wherein the determining of whether the analog input signal has been abnormally modulated comprises:
counting a number of detection windows in which it is determined that abnormal modulation has occurred, for a time which is longer than a duration of each detection window;
determining whether the number of detection windows counted is greater than a second number; and
if it is determined that the number of detection windows counted is greater than the second number, determining that the analog input signal has been abnormally modulated.

6. The method of claim 5, wherein the determining of whether the analog input signal has been abnormally modulated further comprises if it is determined that the analog input signal has been abnormally modulated, determining a grade of abnormal modulation based on the demodulation parameters used to demodulate the analog input signal.

7. The method of claim 1, wherein the analog input signal is an amplitude-modulated Sound Intermediate Frequency (SIF).

8. A receiver for compensating for an abnormal modulation signal, the receiver comprising:
a baseband signal generator which generates a baseband signal by demodulating an analog input signal, which has been modulated according to modulation parameters, using demodulation parameters corresponding to the modulation parameters;
a sampler which samples the baseband signal at a sampling rate;
an abnormal modulation detector which counts a number of samples having an amplitude greater than a threshold level during a detection window and determines whether the analog input signal has been abnormally modulated, based on the number of samples counted;
a demodulation parameter modifier which modifies the demodulation parameters according to the determination result if it is determined that the analog input signal has been abnormally modulated; and
an output unit which synchronizes a result, which is obtained by demodulating the analog input signal according to the modified demodulation parameters, with an image signal and outputs the synchronization result.

9. The receiver of claim 8, wherein the abnormal modulation detector determines whether the analog input signal has been abnormally modulated, based on whether the number of samples counted is greater than a first number.

10. The receiver of claim 8, wherein the baseband signal generator comprises:
a mixer which receives the analog input signal and mixes the analog input signal with a mixing frequency;
a carrier wave remover which removes a carrier wave from the analog input signal; and
a demodulator which generates the baseband signal by applying the demodulation parameters to an output of the carrier wave remover.

11. The receiver of claim 10, wherein the output of the carrier wave remover is a mono signal, a stereo signal, or a dual signal.

12. The receiver of claim 8, wherein the abnormal modulation detector counts a number of detection windows in which it is determined that abnormal modulation has occurred, for a time which is longer than a duration of each detection window, determines whether the number of detection windows counted is greater than a second number, and determines that the analog input signal has been abnormally modulated, if it is determined that the number of detection windows counted is greater than the second number.

13. The receiver of claim 11, wherein the abnormal modulation detector determines a grade of abnormal modulation based on the demodulation parameters used to demodulate the analog input signal, if it is determined that the analog input signal has been abnormally modulated.

14. The receiver of claim 8, wherein the analog input signal is an amplitude-modulated Sound Intermediate Frequency (SIF).

15. The receiver of claim 8, wherein the receiver is an embedded TV receiver, a pluggable TV receiver, or a set-top box.
